(19) United States
(12) Patent Application Publication
(10) Pub. No.: US 2026/0277067 A1
(43) Pub. Date: Sep. 17, 2026

(54) ZONED ELECTRO-OPTIC ELEMENT

(71) Applicant: Gentex Corporation, Zeeland, MI (US)

(72) Inventors: Ryan Barrido Balili, Holland, MI (US); David J. Cammenga, Holland, MI (US)

(73) Assignee: Gentex Corporation, Zeeland, MI (US)

(21) Appl. No.: 19/166,630

(22) PCT Filed: Mar. 13, 2025
(86) PCT No.: PCT/IB2025/052678

§ 371 Date: Sep. 18, 2025

Related U.S. Application Data
(60) Provisional application No. 63/565,568, filed on Mar. 15, 2024.

(51) Int. Cl. G02F 1/163; G02F 1/133; G02F 1/155

(52) U.S. Cl. CPC G02F 1/163; G02F 1/13306; G02F 1/155

(57) ABSTRACT

An electro-optic device includes a first substrate and a second substrate that face each other to define a gap. A lower electrode is segmented such that it defines a plurality of electrode segments including a first electrode segment and a second electrode segment adjacent to the first electrode segment. An upper electrode is segmented substantially the same as the lower electrode. An electro-optic medium is disposed in the gap between the lower and upper electrodes and switchable between states. A control system receives an instruction to switch the electro-optic medium in the first electrode segment and applies a higher electric potential and a lower electric potential to the first electrode segments. A high and low intermediate electric potential is applied to the second electrode segments, the intermediate electric potentials having an average electric potential equal to an average of the higher electric potential and the lower electric potential.

### CROSS-REFERENCE TO RELATED APPLICATION

This application claims priority to and the benefit under 35 U.S.C. § 119(e) of U.S. Provisional Patent Application No. 63/565,568, filed on Mar. 15, 2024, entitled “ZONED ELECTRO-OPTIC ELEMENT,” by Ryan Barrido Balili, et al., the entire disclosure of which is incorporated herein by reference.

### FIELD OF THE DISCLOSURE

The present disclosure generally relates to an electro-optic device with a plurality of pairs of individually activatable electrode segments and a system that controls coloring between pairs of electrode segments adjacent to one or more electrode segments that have been activated.

### SUMMARY OF THE DISCLOSURE

According to an aspect of the present disclosure, an electro-optic device includes a first individually addressable zone and a second individually addressable zone adjacent to the first zone. A lower electrode includes a first lower electrode segment in alignment with the first zone and a second lower electrode segment in alignment with the second zone. An upper electrode includes a first upper electrode segment in alignment with the first zone and a second upper electrode segment in alignment with the second zone. An electro-optic medium is located between the lower and upper electrode segments and configured to switch between one of a high transmissive state, an intermediate transmissive state, and a low transmissive state. A control system is configured to receive an instruction to switch the state of the electro-optic medium in the first zone to one of the intermediate and low transmissive states. A higher electric potential is applied to one of the first upper and lower electrode segments and a lower electric potential is applied to the other one of the first upper and lower electrode segments. The higher electric potential being greater than the lower electric potential with an average electric potential equally between the higher electric potential and the lower electric potential. A high intermediate electric potential is applied to one of the second upper and lower electrode segments and a low intermediate electric potential is applied to the other of the second upper and lower electrode segments, wherein an average intermediate electric potential between the low and high intermediate electric potentials is substantially equal to the average electric potential and the electro-optic medium in the second zone is in a more transmissive state than the first zone.

According to another aspect of the present disclosure, an electro-optic device includes a first individually addressable zone and a second individually addressable zone adjacent to the first zone. A lower electrode includes a first lower electrode segment in alignment with the first zone and a second lower electrode segment in alignment with the second zone. An upper electrode includes a first upper electrode segment in alignment with the first zone and a second upper electrode segment in alignment with the second zone. An electro-optic medium is located between the lower and upper electrode segments and configured to switch between one of a high transmissive state, an intermediate transmissive state, and a low transmissive state. A control system is configured to receive an instruction to switch the state of the electro-optic medium in the first zone to one of the intermediate and low transmissive states. A higher electric potential is applied to one of the first upper and lower electrode segments and a lower electric potential is applied to the other one of the first upper and lower electrode segments. The higher electric potential being greater than the lower electric potential with an average electric potential equally between the higher electric potential and the lower electric potential. A high intermediate electric potential is associated with a voltage that is less than a voltage associated the higher electric potential is applied to one of the second upper and lower electrode segments and a low intermediate electric potential is associated with a voltage that is greater than a voltage associated with the lower electric potential is applied to the other of the second upper and lower electrode segments. An average intermediate electric potential between the low and high intermediate electric potentials is substantially equal to the average electric potential and the electro-optic medium in the second zone is in a more transmissive state than the first zone.

According to yet another aspect of the present disclosure, an electro-optic device includes a plurality of individually addressable zones, each addressable zone including a lower electrode segment and an upper electrode segment. An electro-optic medium is located between the lower and upper electrode segments and configured to switch between one of a high transmissive state, an intermediate transmissive state, and a low transmissive state. A control system is configured to receive an instruction to switch the state of the electro-optic medium within the first zone of the plurality of zones to one of the intermediate and low transmissive states and apply a high electric potential difference to the first zone. A first intermediate electric potential difference that is less than the high electric potential difference is applied to a second zone of the plurality of zones adjacent to the first zone. A second intermediate electric potential difference that is less than the first intermediate electric potential difference is applied to a third zone of the plurality of zones adjacent to the second zone, wherein the second zone spaces the first zone from the third zone.

The present disclosure generally provides an electro-optic device with a plurality of individually addressable zones. Each zone may include a lower electrode segment and an upper electrode segment. A control system applies different electrical potential differences between the plurality of zones to minimize the migration of oxidized anodic and reduced cathodic species in an electro-optic medium between zones for optimal control to changes in transmissivity between the plurality of zones.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1A is a cross-sectional view of an electro-optic device of a first construction, according to an aspect of the present disclosure;

FIG. 1B is a cross-sectional view of an electro-optic device of a second construction, according to an aspect of the present disclosure;

FIG. 2 is a perspective view of electrode segments in an electro-optic device, according to an aspect of the present disclosure;

FIG. 3A is a top view of a vehicle incorporating an electro-optic assembly, according to an aspect of the present disclosure;

FIG. 3B is an upper perspective view of an aircraft incorporating an electro-optic assembly, according to an aspect of the present disclosure;

FIG. 3C is an elevational view of a building incorporating an electro-optic assembly, according to an aspect of the present disclosure;

FIG. 3D is an upper perspective view of an eyewear assembly incorporating an electro-optic assembly, according to an aspect of the present disclosure;

FIGS. 4A-4F depict a series of electric potential differentials applied between adjacent electrode segments of an electro-optic device, according to an aspect of the present disclosure; and

FIG. 5 is a schematic view of a control system that controls functionalities of a monitoring system, according to an aspect of the present disclosure.

### DETAILED DESCRIPTION

The present illustrated embodiments reside primarily in combinations of method steps and apparatus components related to an electro-optic device with a plurality of pairs of individually activatable electrode segments and a system that controls coloring between pairs of electrode segments adjacent to one or more electrode segments that have been activated. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

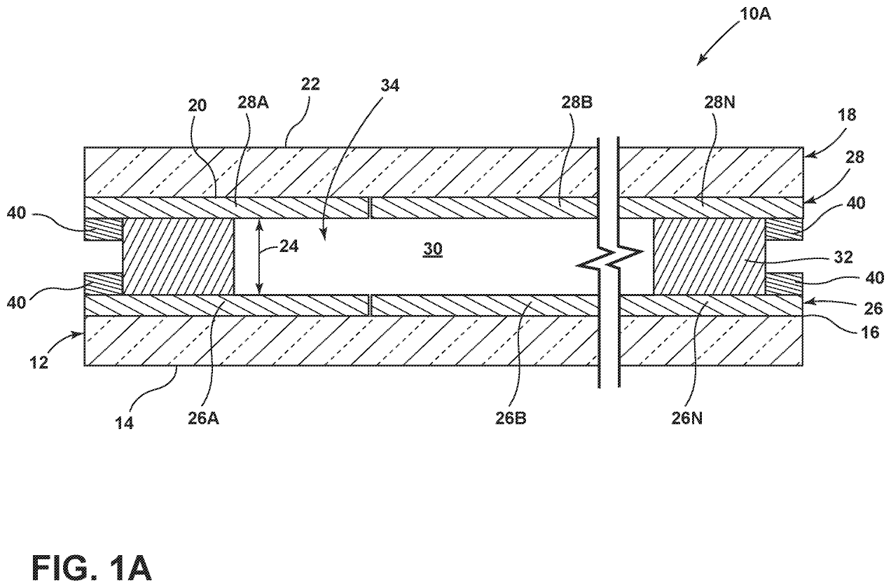

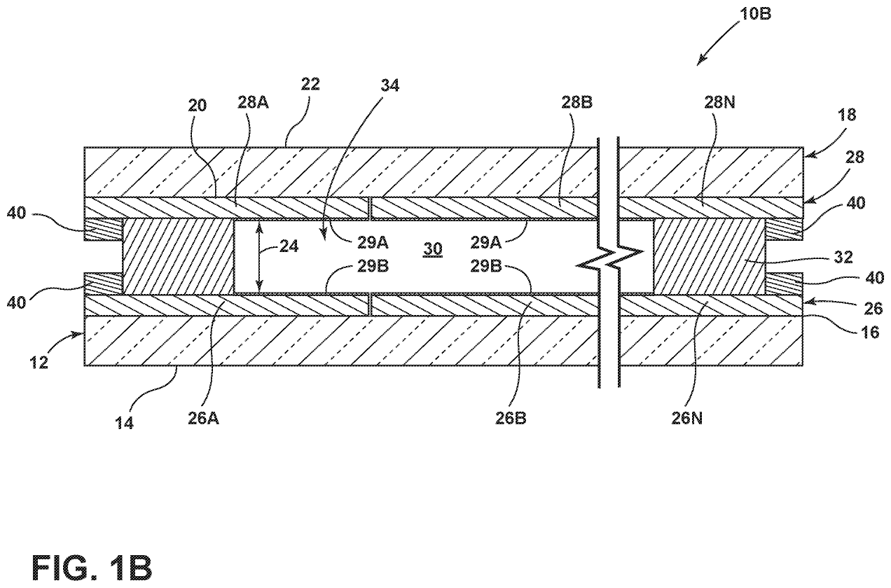

For purposes of description herein, the terms “upper,” “lower,” “right,” “left,” “rear,” “front,” “vertical,” “horizontal,” and derivatives thereof, shall relate to the disclosure as oriented in FIG. 1A. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring initially to FIGS. 1A and 2-5, reference numeral 10A generally designates an electro-optic device 10A of a first construction. In the first construction 10A, the electro-optic device 10A may include a solution-phase configuration. The electro-optic device 10A includes a first substrate 12 having a first surface 14 and a second surface 16 and a second substrate 18 having a third surface 20 and a fourth surface 22. The second substrate 18 is disposed in a substantially spaced apart relationship relative to the first substrate 12 such that the second and third surfaces 16, 20 face one another to define a gap 24. A lower electrode 26 is associated with the second surface 16 and is segmented such that it defines a plurality of lower electrode segments 26A-26N including a first lower electrode segment 26A and a second lower electrode segment 26B is adjacent to the first lower electrode segment 26A. An upper electrode 28 is associated with the third surface 20 and is arranged in upper electrodes segments 28A-28N substantially according to the plurality of lower electrode segments 26A-26N established by the lower electrode 26. An electro-optic medium 30 is disposed in the gap 24 between the lower and upper electrodes 26, 28 and configured to switch between one of a high transmissive state, intermediate transmissive states, and a low transmission state (e.g., fully darkened).

The electro-optic device 10A includes a plurality of individually addressable zones defined between pairs of the upper and lower electrode segments. It should be appreciated that the terms “upper” and “lower” are meant to distinguish between electrodes 26 and 28 without implying that one electrode is necessarily intended to have an orientation with respect to an intended viewer. Likewise, the “electrode segments” as defined herein may also be referred to as “zone segments” in association with the electrode segments within a particular zone. In addition, it should be appreciated that the electrode segments may also be referred to as “electrode regions” meaning different areas of an electrode that may or may not include isolation lines or components between adjacent regions.

A control system 100 (e.g., a processor 104) is configured to receive an instruction to switch the state of the electro-optic medium 30 between the first lower and upper electrode segments 26A, 28A and apply a higher electric potential to the first lower and upper electrode segments 26A, 28A associated with one of the lower or upper electrodes 26, 28 and a lower electric potential to the first lower and upper electrode segments 26A, 28A associated with the other of the lower or upper electrodes 26, 28. The higher electric potential is greater than the lower electric potential with an average electric potential equally between the higher electric potential and the lower electric potential. The electro-optic medium 30 between the first lower and upper electrode segments 26A, 28A being in the low transmissive state or one of the intermediate transmissive states. A high intermediate electric potential is applied to the second lower and upper electrode segments 26B, 28B associated with one of the lower or upper electrodes 26, 28 and a low intermediate electric potential is applied to the second lower and upper electrode segments 26B, 28B associated with the other of the lower or upper electrodes 26, 28. An average electric potential between the low and high intermediate electric potentials is substantially equal to the average electric potential between the higher electric potential and the lower electric potential. The electro-optic medium 30 between the second lower and upper electrode segments 26B, 28B is in the high transmissive state or a different one of the intermediate transmissive states.

With continued reference to FIGS. 1A and 2-5, the upper electrode 28 is segmented with upper electrode segments 28A-28N substantially according to the plurality of lower electrode segments 26A-26N established by the lower electrode 26. As such, the upper electrode 28 includes at least a first upper electrode segment 28A in a first zone with the lower electrode segment 26A, a second upper electrode segment 28B in the second zone with the second lower electrode segment 26B, and may include a plurality of additional upper and lower electrode segments (e.g., pairs) associated with different zones as designated 28N. In other words, the upper electrode 28 and the lower electrode 26 both include at least the first lower and upper electrode segments 26A, 28A and the second lower and upper electrode segments 26B, 28B two facilitate the individualized accessibility of the first and second zones. It is contemplated that the upper electrode 28 or the lower electrode 26 may have more segments than the other of the upper electrode 28 or the lower electrode 26, however, both include at least the first lower and upper electrode segments 26A, 28A and the second lower and upper electrode segments 26B, 28B that are segmented substantially accordingly with one another to define the first and second zones, respectively. The first lower and upper electrode segments 26A, 28A and the second lower and upper electrode segments 26B, 28B may be defined by electrically insulating isolation lines.

The electro-optic device 10A (e.g., the electro-optic medium 30) may include at least one cathodic species and at least one anodic species. The electro-optic device 10A may further include at least one anodic and cathodic buffer. The buffer material oxidation reduction pair may have a lower oxidation/reduction potential when compared to the primary darkening anodic and cathodic species (e.g., pair or pairs). As a result, if present, the buffer pair will oxidize and reduce before the primary oxidation reduction species. It is also preferred that the buffer materials have a significantly lower coloration efficiency when compared to the primary oxidation reduction pair. It is preferred that the buffer materials are not highly colored in the oxidized or reduced forms.

With continued reference to FIG. 1A, in some embodiments, the electrodes 26, 28 may include a transparent conductive oxide (such as indium tin oxide and/or doped zinc oxide), a metal coating, conductive nanowire coating, a conductive metal mesh, an insulator/metal/insulator stack (IMI stack), a transparent polymer filled with nanoparticles (such as indium tin oxide particles), carbon nanotubes, graphene, or a conductive polymer (which may be integral to first and second substrates 12, 18. The electro-optic medium 30 may contain the at least one cathodic species (i.e., a material that is reducible), the at least one anodic species (i.e., a material that is oxidizable), or a mixture of a cathodic and an anodic species. The electro-optic medium 30 may be solid state, solution phase, a gel, or a polymer-based material such as a thermoplastic material or a cross-linked material. In some embodiments, the electro-optic medium 30 may be a solution phase electrochromic system. One or both of the cathodic and anodic materials may be confined to one or both of the first and second substrates 12, 18 and/or electrodes 26, 28. The electro-optic medium 30 may also contain an electrolyte to facilitate charge movement between electrodes 26, 28.

The electro-optic device 10A may include an outer seal 32, such that an impermeable cavity 34 is formed between the outer seal 32, and the lower and upper electrodes 26, 28. The electro-optic element 10A may be configured to hold specific transmission states within the different lower and upper electrodes. The different transmission states may be achieved by applying a specific electric potential difference (i.e., the lower and higher electric potentials) to one or more particular lower and upper electrodes in a zone. In some embodiments, the lower and upper electrodes 26, 28 may include one or more additional conductive layers to distribute the applied potential. The applied potential difference results in an absorbance change of the electro-optic medium 30, thus impacting transmissivity resulting in dimming and undimming the electro-optic element 10A.

In some embodiments, the electro-optic medium 30 may include at least one solvent, at least one anodic material, and at least one cathodic material. Typically, both of the anodic and cathodic materials are electroactive and at least one of them may be electrochromic. It will be understood that regardless of its ordinary meaning, the term “electroactive” will be defined herein as a material that undergoes a modification in its oxidation state upon exposure to a particular electric potential difference (e.g., greater than minimum electric potential difference). Additionally, it will be understood that the term “electro-optic” will be defined herein, regardless of its ordinary meaning, as a material that exhibits a change in its extinction coefficient at one or more wavelengths upon exposure to a particular electric potential difference (e.g., greater than minimum electric potential difference). Electro-optic components, as described herein, include materials whose color, reflectivity, polarization, phase, or absorbance are affected by an applied voltage differential. The electro-optic components as disclosed herein may be a single-layer, single-phase component, multi-layer component, a solution phase electrochromic system, or multi-phase component.

With reference now to FIGS. 1B and 2-5, an electro-optic device 10B is depicted in a second construction. In the second construction, the electro-optic device 10B may be configured as a solid-state device rather than the solution-phase device depicted in FIG. 1A. However, it should be appreciated that these constructions are exemplary in nature and other electro-optic constructions may be utilized under the principles described herein. Further, like components between the first and second constructions share the same reference numerals. Generally speaking, the electro-optic device 10B of the second construction shares all the same components, functionalities, and operating principles of the electro-optic device 10A of the first construction. However, the electro-optic device 10B and, more particularly, the electro-optic medium 30 further includes an anodic film 29A and a cathodic film 29B that are coupled (e.g., connected, directly or indirectly layered on) to one of the lower electrodes 26 and the upper electrode 28, respectively. In some embodiments, the anodic film 29A and the cathodic film 29B may both be located between the lower electrode 26 and the upper electrode 28. In some implementations, the anodic and cathodic films 29A, 29B may be segmented in accordance with the upper and lower electrodes 26, 28. In some implementations, the anodic and cathodic films 29A, 29B may be configured as homogenous layers with uniform concentrations of either anodic species or cathodic species. While the anodic film 29A is depicted as being coupled to the upper electrode 28 and the cathodic film 29B is depicted as being coupled to the lower electrode 26, the location of the anodic and cathodic films 29A, 29B may be reversed. The electro-optic medium 30 may include an electrolyte (e.g., a thin-film electrode or electrolyte) sandwiched between the anodic and cathodic films 29A, 29B. Each electrode 26, 28 experiences a change in charge from the injection and removal of electrons (cathodic and anodic, respectively). In some embodiments, the at least one anodic species includes a phenazine derivative and the at least one cathodic species includes a viologen derivative.

Regardless of the construction of the electro-optic device 10A, 10B, as used herein, the terms “higher electric potential,” “lower electric potential,” “average electric potential,” and “intermediate electric potential” are used to designate respective proportional relationships between each other and do not impart absolute values. In other words, the higher electric potential may be any value and the low and average electric potentials will be less than the higher electric potential. Likewise, the lower electric potential may be any value, including values that may be traditionally considered large, but the higher and average electric potentials will be greater. In this manner, while various examples are provided of these various electric potentials, it should be appreciated that these electric potentials may be any value, as long as the higher electric potential is greater than the lower and average electric potentials, and the intermediate electric potentials are between the higher and lower electric potential. In some implementations, the low and high intermediate electric potentials may be substantially equal to the average electric potential and applied to both electrodes 26B, 28B. In other implementations, the low and high intermediate electric potentials may be substantially unequal to the average electric potentials and applied to the electrodes 26B, 28B, respectively. More particularly, the low and high intermediate electric potentials are each equal to or between the average electric potential and the higher and lower electric potentials (e.g., proportionally). In other words, when the low and high intermediate electric potentials are employed, they may each be equal but opposite relative to the average electric potential. In this manner, the low and high intermediate electric potentials may have an average electric potential that is substantially equal to the lower and higher electric potentials.

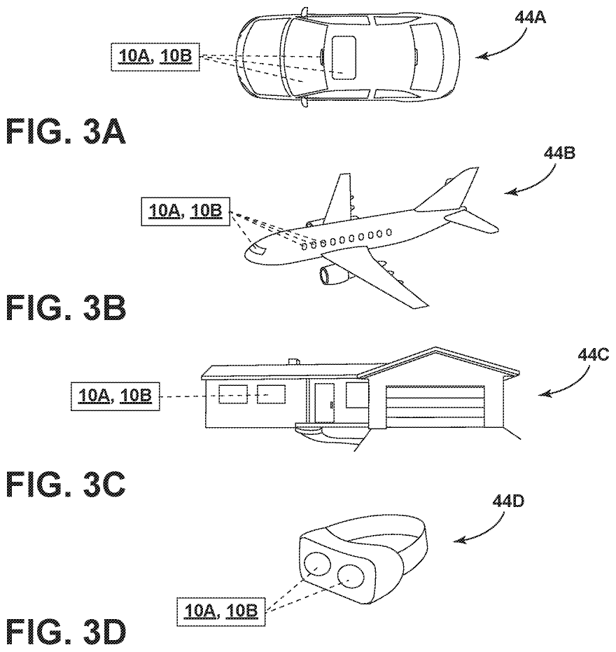

With reference now to FIGS. 3-5, depending on the electro-optic medium 30 and the anodic and cathodic species (e.g., in the anodic and cathodic films 29A, 29B and/or electro-optic medium 30), a minimum electric potential difference may be needed before the electro-optic medium 30 undergoes a noticeable change in state (e.g., between one of the high transmissive state, the intermediate transmissive states, or the fully darkened state). In this manner, it should be appreciated that when the low and high intermediate electric potentials are substantially equal to the average electric potential, the low and high intermediate electric potentials may be equal or about equal to the average electric potential or in a range within (e.g., below) the minimum electric potential difference required to switch states (e.g., darken). Further, when the high intermediate electric potential and low intermediate potential are equal or about equal to each other, the second lower electrode segment 26B, 28B may have only a very low concentration of oxidized anodic species and reduced cathodic species present. This may result in transmission substantially equal to the high transmission state. It should be appreciated that the low concentration of either oxidized anodic species (e.g., one or more) or reduced cathodic species (e.g., one or more) applies to the anodic and cathodic species only, and not the anodic or cathodic buffers, which may have relatively low electric potential oxidation/reduction requirements when compared to the anodic and cathodic species.

With continued reference to FIGS. 3-5, the electro-optic medium 30 is switchable between one of a high transmissive state or a low transmissive state (e.g., a fully darkened state) or an intermediate transmissive state. More particularly, the electro-optic medium 30 may include a high transmissive state associated with the minimum electric potential difference and a low transmissive state associated with a maximum electric potential difference as set by the control system 100. In some embodiments, the lower and higher electric potentials have a potential difference that is equal to the maximum electric potential difference and the intermediate potentials have a potential difference that is about equal to or less than the minimum potential difference. In this manner, when the intermediate potentials have a potential difference that is within (e.g., below) the minimum potential difference, the electro-optic medium 30 may be in the high transmissive state (e.g., before the electro-optic medium 30 undergoes a noticeable change in state from the high transmissive state). When the intermediate potentials have a potential difference that is equal to or slightly greater than the minimum potential difference, the electro-optic medium 30 may be in an intermediate transmissive state, for example, within 1% of the high transmissive state, within 2% or less, within 3% or less, within 4% or less, within 5% or less, within 10% or less, or within 15% or less.

The control system 100 of the electro-optic device 10A, 10B controls coloring of the second lower and upper electrode segments 26B, 28B by applying the high and low intermediate electric potentials thereto when the first lower and upper electrode segments 26A, 28A have been activated to reduce, prevent, or eliminate color segregation into the electro-optic medium 30 between the second lower and upper electrode segments 26B, 28B. More particularly, in traditional systems the color segregation appears as binary regions of lingering colors even after a clearing cycle is or has been in operation. Color segregation is a visible manifestation of a physical, lateral separation of oxidized anodic and reduced cathodic species in the electro-optic medium 30. One of the driving factors of color segregation is electric field-driven, or more particularly, an effective lateral electric field is applied may cause the oxidized anodic and reduced cathodic species to migrate to lower and upper electrodes adjacent to an activated zone. In this manner, both the lower and upper electrodes 26, 28 are held at the intermediate electric potentials as a first order approximation. For the purpose of this disclosure “first order approximation” may mean adjustments must be made to account for the degree of asymmetry of the electro-optic device 10A, 10B construction and differences in chemical properties and physical constants of the various components of the electro-optic device 10A, 10B. As will be described in further detail below, by holding both the lower and upper electrodes 26, 28 in the second lower and upper electrode segments 26B, 28B at the intermediate electric potentials, the lateral electric field effectively cancels out.

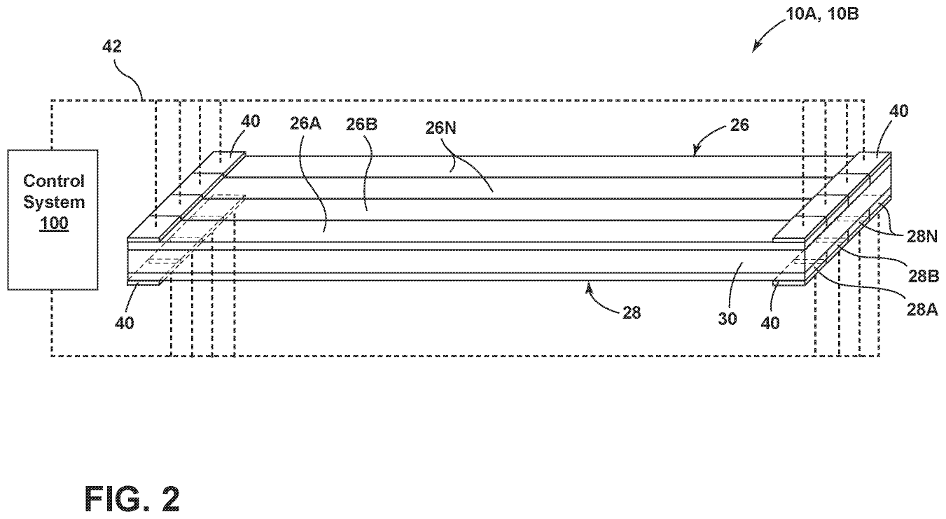

With reference now to FIGS. 1A-2, an electric bus 40 may include segments that at least partially travel along opposite peripheral edges of the cavity 34 on the lower and upper electrodes 26, 28 (e.g., in electrical contact with the various segments or lower electrode segments 26A-26N, 28A-28N). For example, the electric bus 40 may include a conductive adhesive, conductive epoxy, conductive ink, metal strips or clips, conductive tape, and/or the like, that may include a higher electric conductivity than one or both of the lower and upper electrodes 26, 28. The electric bus 40 may include segments placed on an internal surface (e.g., a surface that faces towards the cavity 34) of the lower and upper electrodes 26, 28 or the electric bus 40 may include segments placed on an outer surface (e.g., a surface that faces away from the cavity 34) of the lower and upper electrodes 26, 28. As depicted, the electric bus 40 may be segmented such that each segment is assigned to a single electrode segment such that each single electrode segment and associated zone is individually addressable.

With reference now to FIG. 2, the electro-optic device 10A, 10B may include a plurality of individually controlled lower and upper electrodes 26N, 28N in addition to the first lower and upper electrode segments 26A, 28A and the second lower and upper electrode segments 26B, 28B. The number, size, and shape of the zones and corresponding electrode segments may vary. Each pair of lower and upper electrodes in a zone may be individually controlled by conductors 42 (e.g., traces) that extend to each electrode segment (e.g., each segment of the bus 40). As depicted, the lower electrode 26 and the upper electrode 28 define a series of isolation lines that separate and conductively isolate the various lower and upper electrode segments 26A-26N and 28A-28N. The isolation lines may be spaces or channels located between the various lower electrode segments 26A-26N. In some implementations, a high resistive material may be located in the spaces or channels that define the isolation lines. The electro-optic medium 30 may extend within the cavity 34 without any internal barriers or, alternatively, the electro-optic medium 30 may be segmented in accordance with the various zones. In operation, controlling which portion of the electro-optic device 10A, 10B changes states can be dictated by electro-activating select conductors 42 and energizing segments of the electric buses 40 associated with one or more of the various lower and upper electrode segments 26A-26N and 28A-28N.

With reference now to FIGS. 3A-3D, the electro-optic medium 30 may be switchable between the high transmissive state, the intermediate transmissive states, and the fully darkened or absorbing state (e.g., darkening to prevent glare from a window or mirror). In other embodiments, the electro-optic device 10A, 10B may include a reflective layer and be switchable between a high reflectance state (e.g., associated with the high transmissive state and semi-transmissive intermediate transmissive states) and a low reflectance state (e.g., associated with the fully darkened state and substantially darkened intermediate transmissive states) in mirror applications. When a reflective layer is employed, it may be located behind the electro-optic medium 30 with respect to an intended viewer.

The electro-optic device 10A, 10B may be incorporated with one or more structures 44A-44D including at least those depicted in FIGS. 3A-3D. FIG. 3A illustrates an automobile 44A employing the electro-optic device 10A, 10B, for example, with an interior rearview mirror, a sunroof, a windshield, a side window, a heads-up display, combinations thereof, and/or other interior vehicle locations. The automobile 44A may include a commercial vehicle, an emergency vehicle, a residential vehicle, or the like. FIG. 3B illustrates an aircraft 44B employing the electro-optic device 10A, 10B (e.g., a front window, side window, heads-up display). FIG. 3C illustrates a building 44C employing electro-optic device 10A, 10B (e.g., a window). The building 44C may be a residential building, a commercial building, and/or the like. FIG. 3D illustrates eyewear 44D employing electro-optic device 10A, 10B. For example, the eyewear may be glass with a dimming functionality, augmented reality, mixed reality, virtual reality, and/or the like. Generally speaking, the electro-optic device 10A, 10B may be incorporated into any environment where electrochromic effects are beneficial, such as changing the state of a window, mirror, display, and/or other structures and environments.

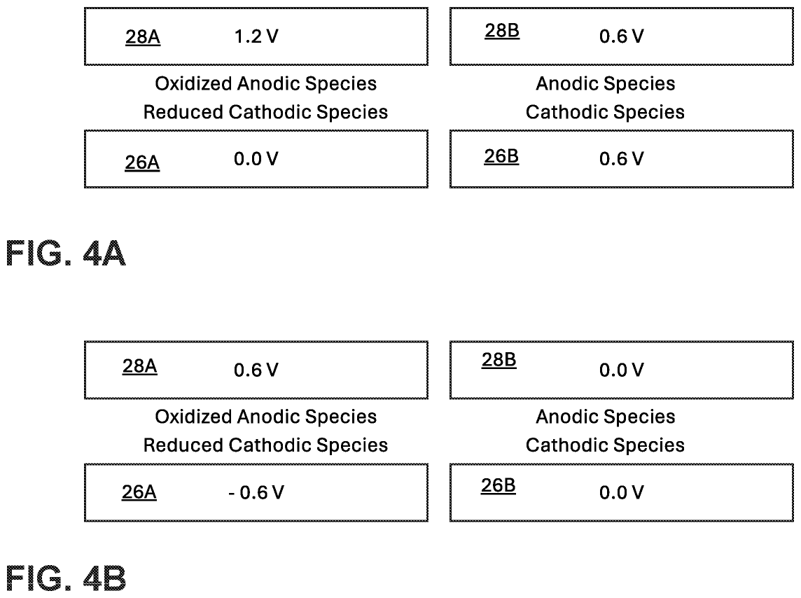

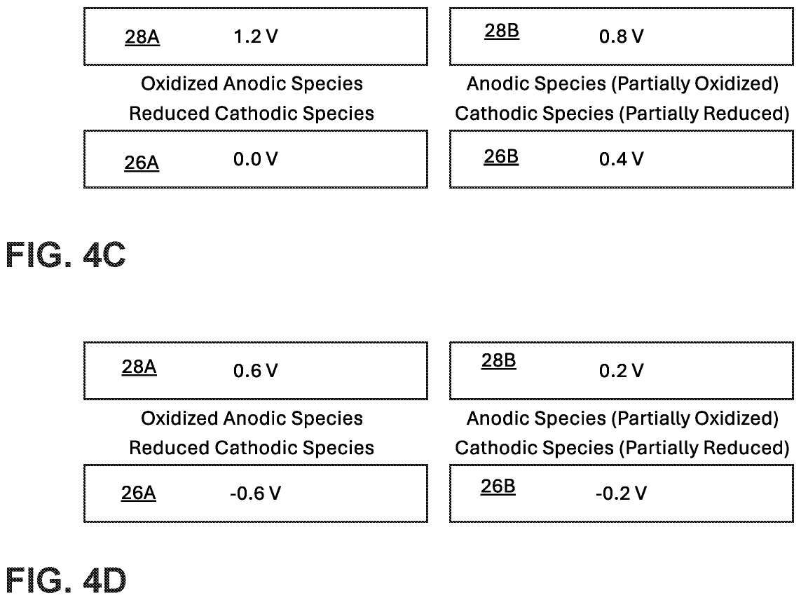

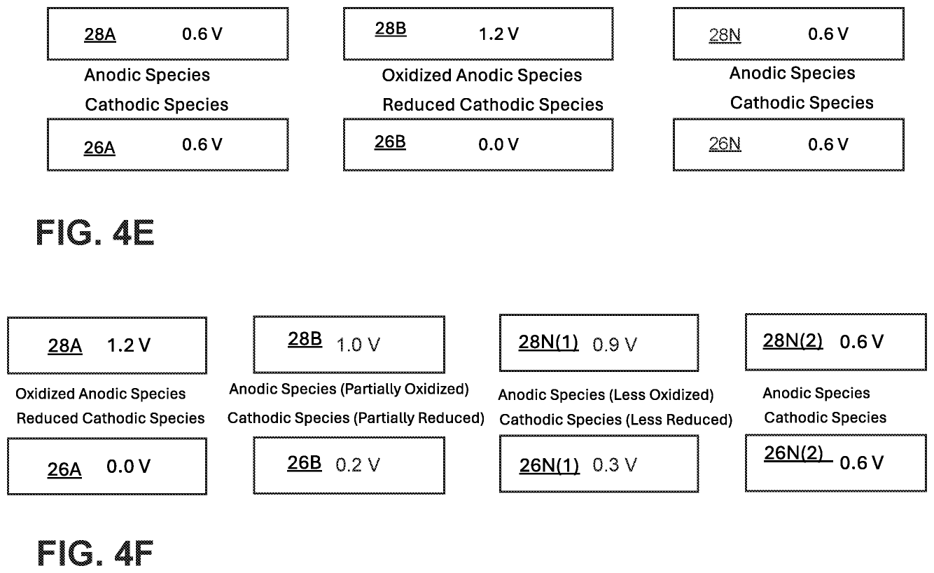

With reference now to FIGS. 4A-4F, various examples of the higher, lower, average, and intermediate electric potentials are illustrated. The intermediate electric potentials may either be substantially equal and applied to the second lower and upper electrode segments 26B, 28B or different and applied to the second lower and upper electrode segments 26B, 28B. When the intermediate electric potentials are substantially equal, the intermediate electric potentials will also be substantially equal to the average electric potential of the higher electric potential and the lower electric potential and/or within the minimum electric potential difference. Regardless of the higher and lower electric potentials, by employing intermediate electric potentials substantially equal to the average, the color segregation is reduced or eliminated by preventing or reducing excess or net gain of either oxidized anodic species or reduced cathodic species. Driving the intermediate electric potentials, rather than shorting the second lower and upper electrode segments 26B, 28B or allowing upper electrode segment 28B to float, reduces the migration of oxidized and reduced species. The intermediate electric potentials may be defined as the low intermediate electric potential (e.g., lower than or equal to an average intermediate electric potential) and the high intermediate electric potential (e.g., higher than or equal to the average intermediate electric potential). The high intermediate electric potential has a first proportional relationship to the higher electric potential from the average electric potential and the low intermediate electric potential has a second proportional relationship to the lower electric potential from the average electric potential. As will be described below with reference to specific examples, the first proportional relationship and the second proportional relationship may be substantially equal, such that the average intermediate electric potential is substantially equal to the average of the higher and lower electric potentials. In some embodiments, the polarities are switched between the first lower electrode segments 26A, 26A and the second lower and upper electrode segments 26B, 28B. In such scenarios, the higher electric potential associated with the first lower and upper electrode segments 26A, 28A is applied to the lower or upper first lower electrode segments 26A, 28A and the intermediate higher electric potential is applied to the other of the lower or upper electrode in the second lower and upper electrode segments 26B, 28B. Stated another way, the low intermediate electric potential is applied to a different one of the second lower and upper electrode segments 26B, 28B than the lower electric potential is applied and the high intermediate electric potential is applied to a different one of the second lower and upper electrode segments 26B, 28B than the higher electric potential is applied. In some embodiments, the low intermediate electric potential is between the lower electric potential and the average electric potential and the high intermediate electric potential is between the higher electric potential and the average electric potential.

With reference now specifically to FIG. 4A, the electro-optic device 10A, 10B is depicted with a higher electric potential value at the lower electrode 26A that is 1.2V higher (e.g., electric potential difference) than a lower electric potential value at the upper electrode 28A. In such operating values, the intermediate electric potentials in the lower and upper electrodes 26B, 28B are both substantially held at the average electric potential, which is 0.6V above the low electric potential voltage and 0.6V below the high electric potential voltage. In the electro-optic device 10A, 10B depicted in FIG. 4B, the potential differences between the higher electric potential, the lower electric potential and intermediary electric potentials are the same as in FIG. 4A. However, the reference potential is shifted down by 0.6V. In such operating values, the intermediate electric potentials in the lower and upper electrodes 26B, 28B are both substantially held at the average electric potential, which is 0.6V above the low electric potential voltage and 0.6V below the high electric potential voltage. In the electro-optic device 10A, 10B depicted in FIG. 4C, the electro-optic device 10A, 10B is depicted with a higher electric potential value at the lower electrode 26A that is 1.2V higher than a lower electric potential value at the upper electrode 28A. The high intermediate electric potential has a value that is between the average electric potential and the higher electric potential. Similarly, the low intermediate electric potential has a value that is between the average electric potential and the lower electric potential. The average voltage potential between the lower electrode segments 26A, 28A and the upper electrode segment 26B, 28B are substantially equal. In the electro-optic device 10A, 10B depicted in FIG. 4D, the potential differences between the higher electric potential, the lower electric potential and intermediary electric potentials are the same as in FIG. 4A. However, the reference potential is shifted down by 0.6V. The high intermediate electric potential has a value that is between the average electric potential and the higher electric potential. Similarly, the low intermediate electric potential has a value that is between the average electric potential and the lower electric potential. The average voltage potential between the lower electrode segments 26A, 28A and the upper electrode segment 26B, 28B are substantially equal. In FIGS. 4A and 4B, the electro-optic medium 30 between the second lower and upper electrode segments 26B, 28B is cleared and/or substantially close to the high transmissive state. In FIGS. 4C and 4D, the electro-optic medium 30 between the second lower and upper electrode segments 26B, 28B is in a controlled intermediate transmissive state.

With reference back to FIGS. 4A-4D, when the intermediate electric potentials are substantially equal to the average electric potential, the anodic and cathodic species in the first lower and upper electrode segments 26A, 28A are oxidized or reduced, respectively, while the second lower and upper electrode segments 26B, 28B has a substantial reduction or prevention of excess or net gain of either oxidized anodic species or reduced cathodic species. On the other hand, when the intermediate electric potentials are not substantially equal to the average electric potential, the anodic and cathodic species between the second lower and upper electrode segments 26B, 28B may be controlled (e.g., a net decrease in oxidation and/or reduction than anodic and cathodic species between the first lower and upper electrode segments 26A, 28A). In this manner, the electric potential applied to various electrode segments can be precisely controlled to either prevent species in adjacent electrode segments from undergoing changes or drive species in adjacent zones to undergo less or more changes (i.e., in a gradient-type pattern or any other desired pattern). When the adjacent electrode segment undergoes less changes, the reduced or oxidized species may be able to migrate into the adjacent electrode segment, but the driven applied potential difference dictates the amount of oxidized and reduced species within that electrode segment thus allowing precise control between electrode segments. Further, as previously explained, the electro-optic device 10A, 10B may include at least one anodic and/or cathodic buffer to further cancel any migrating oxidized anodic species, reduced cathodic species, or free electrons. It should be appreciated that the examples illustrated in FIGS. 4A-4D are exemplary in nature, and any high, low, average, and intermediate electric potentials may be utilized and employ the proportional relationships disclosed herein.

With reference now to FIGS. 4E and 4F, modifying the electric potentials between the various electrode segments 26A, 28A-26N, 28N, can be utilized to precisely control the state of the electro-optic medium 30 between electrode segments 26A, 28A-26N, 28N. For example, FIG. 4E depicts the second lower and upper electrode segments 26B, 28B receiving the higher and lower electric potentials while adjacent electrode segments 26A, 28A and 26N, 28N receive an intermediate electric potential substantially equal to the average electric potential. In this manner, despite the second lower and upper electrode segments 26B, 28B being central between adjacent electrode segments, the migration of the reduced and oxidized species is reduced or eliminated and only the second lower and upper electrode segments 26B, 28B is in a darkened state. As depicted in FIG. 4F, a user may want to change the state of the electro-optic medium 30 in a gradient-type pattern. In these situations, the higher and lower electric potentials are applied to one of the electrode segments, for example, the first lower and upper electrode segments 26A, 28A, while the subsequent electrode segments receive intermediate electric potentials that are proportionally valued, sequentially getting closer to the average electric potential. More particularly, the first lower and upper electrode segments 26A, 28A are depicted as receiving the higher and lower electric potentials and, therefore, the electro-optic medium 30 between the first lower and upper electrode segments 26A, 28A may be in the fully darkened state. The second lower and upper electrode segments 26B, 28B are illustrated as having the first lower intermediate electric potential and the second lower intermediate electric potential and, therefore, the electro-optic medium 30 between the second lower and upper electrode segments 26B, 28B is in a partially darkened state. A third electrode segment 26N(1), 28N(1) is illustrated as having intermediate electric potentials closer to the average electric potential and, therefore, the electro-optic medium 30 between the third electrode segment 26N(1), 28N(1) is in a partially darkened state, but less darkened than the electro-optic medium 30 between the second lower and upper electrode segments 26B, 28B. A fourth electrode segment 26N(2), 28N(2) is illustrated as having intermediate electric potentials substantially equal to the average electric potential and, therefore, the electro-optic medium 30 between the fourth electrode segments 26N(2), 28N(2) is in the transmissive state (e.g., high transmissive state). Under these principles one or more gradient effects can be achieved and are only limited by the number of electrode segments.

With continued reference to FIGS. 1A-5, in some embodiments, the higher and lower electric potentials and the high and low intermediate potentials may be at least partially defined by duty cycle. More particularly, when the high intermediate electric potential is substantially equal to the higher electric potential and the low intermediate electric potential is substantially equal to the lower electric potential, color segregation and distinctive gradient coloring can be accomplished by modifying the respective duty cycle in the second lower and upper electrode segments 26B, 28B. For example, the electro-optic device 10A, 10B may have a higher electric potential value at the lower electrode 26A that is 1.2V higher than a lower electric potential value at the upper electrode 28A. The intermediate electric potentials in the upper and lower the second lower and upper electrode segments 26B, 28B may both substantially equal to the higher and lower electric potentials. However, the control system 100 may pulse the intermediate electric potentials at a lower duty cycle than the higher and lower electric potentials. This operating principle can be carried over to the additional electrode segments 26N, 28N. While not meant to be limiting, the higher and lower electric potentials may have a first duty cycle equal to, for example, about 100%. The intermediate electric potential on the electrode segments 26B, 28B in the second zone may have a second duty cycle equal to, for example, about 80%. The intermediate electric potential on the additional electrode segments 26N, 28N (e.g., adjacent to the second lower and upper electrode segments 26B, 28B) may have a second duty cycle equal to, for example, about 60%. In other words, by sequentially reducing the duty cycle between electrode segments, gradient color and/or sequenced intermediate transmissive states can be accomplished.

It should be appreciated that this principle can also be used in scenarios where the intermediate electric potentials are different than the higher and lower electric potentials, where the lower the duty cycle corresponds with a more transmissive state. More particularly, for a 50% duty cycle, the control system 100 applies 1.2V delta at 50% of the time, but not the other 50% percent of the time. When the intermediate electric potentials are not applied the other 50% of the time, the intermediate electric potentials difference may be maintained at about 0.3V delta or another low delta to keep the counter buffers occupied or float the connection both the second lower and upper electrode segments 26B, 28B. As used herein “float” may be defined as switching to high impedance or totally open circuit. In some embodiments, the impedance may be variable. A pulse width modulation (PWM) of the intermediate electric potentials may include applying an intermediate electric potential on at least one of the second lower and upper electrode segments 26B, 28B and then opening the circuit, floating in connection with a high impedance state intermittently (e.g., not necessarily going to zero or some intermediate electric potential difference at some duty cycle).

With reference now to FIGS. 1A-5, in addition to controlling color segregation between adjacent electrode segments by modifying the intermediate electric potentials and/or the duty cycle, the control system 100 may be configured to monitor the open circuit electric potential differences or currents of electrode segments to ensure a desired color segregation is maintained over long periods of time. For example, the control system 100 may monitor the open circuit potential differences or currents of the second lower and upper electrode segments 26B, 28B and/or the additional electrode segments 26N, 28N. If the open circuit potential difference between the electrode segments is not zero, this is an indication that some oxidized or reduced species are present. The control system 100 may be configured to apply a brief reverse potential difference to the electrode segments to clear or partially clear the electro-optic medium 30 between the second lower and upper electrode segments 26B, 28B or the additional electrode segments 26N, 28N.

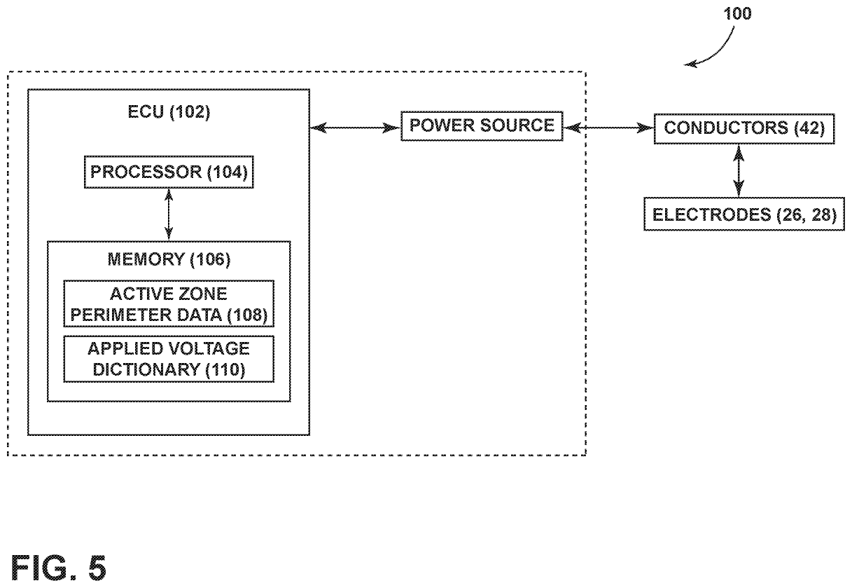

With reference now to FIG. 5, in some embodiments, the control system 100 may include an electronic control unit (ECU) 102. The ECU 102 may include the processor 104 and the memory 106. The processor 104 may include any suitable processor 104. Additionally, or alternatively, the ECU 102 may include any suitable number of processors (e.g., located in one or more structures 44A-44D), in addition to or other than the processor 104. The memory 106 may comprise a single disk or a plurality of disks (e.g., hard drives), and includes a storage management module that manages one or more partitions within the memory 106. In some embodiments, the memory 106 may include flash memory, semiconductor (solid state) memory or the like. The memory 106 may include Random Access Memory (RAM), a Read-Only Memory (ROM), or a combination thereof. The memory 106 may include instructions that, when executed by the processor 104, cause the processor 104 to, at least, perform the functions and method steps as described herein. The electro-optic device 10A, 10B, a power source thereof, and components thereof, may, therefore, be controlled, receive inputs, and/or transmit inputs in relation to the ECU 102. The ECU 102 may receive and/or the memory 106 may save instructions that include active zone perimeter data 108 and an applied potential difference dictionary 110.

In operation, the active zone perimeter data 108 may include instructions that relate to automatically switching states of one, select, or each electrode segments. For example, in some embodiments, the electro-optic device 10A, 10B may include a glare or light sensor (not shown). Based on feedback from the glare or light sensor, the control system 100 may be configured to identify the location of the glare or light and switch the states of the one or more electrode segments associated with that location. In another example, the electro-optic device 10A, 10B may include a display located behind the electro-optic medium 30. Based on feedback (e.g., from a user selecting to turn on the display or the display automatically generating as a result of another condition), the control system 100 may be configured to identify if the display is on and switch states of the electrode segments associated with the display.

As it relates to the applied potential difference dictionary 110, the control system 100 may be configured to select the intermediary electric potentials and/or duty cycle based on one or more conditions or user preferences. For example, a user may prefer a gradient effect, as such the control system 100 may be configured to apply proportional intermediate electric potentials and/or duty cycles to adjacent electrode segments. In other scenarios, it may be beneficial to completely separate states between adjacent electrode segments (e.g., the high transmission state and the fully darkened state). In these scenarios, the control system 100 may be configured to apply a single intermediate electric potential to an adjacent electrode segment that is substantially equal to the average electric potential. Further, the control system 100 may monitor the open circuit electric potential differences of electrode segments to ensure a desired color segregation is maintained over long periods of time. If the open circuit electric potential difference is not maintained within a threshold (e.g., the minimum electric potential difference), the control system 100, via instructions from the active zone perimeter data 108, may be configured to apply a potential difference to reverse the effect (e.g., in pulses or maintained) and to clear or partially clear the electro-optic medium 30 between the second lower and upper electrode segments 26B, 28B.

The disclosure herein is further summarized in the following paragraphs and is further characterized by combinations of any and all of the various aspects described therein.

According to an aspect of the present disclosure, an electro-optic device includes a first substrate having a first surface and a second surface and a second substrate having a third surface and a fourth surface. The second substrate is disposed in a substantially spaced apart relationship relative to the first substrate such that the second and third surfaces face one another to define a gap. A lower electrode is associated with the second surface and is segmented such that it defines a plurality of electrode segments including a first electrode segment and a second electrode segment adjacent to the first electrode segment. An upper electrode is associated with the third surface and is segmented substantially according to the plurality of electrode segments established by the lower electrode. An electro-optic medium is disposed in the gap between the lower and upper electrodes and configured to switch between one of a high transmissive state, intermediate transmissive states, and a low transmissive state. A control system is configured to receive an instruction to switch the state of the electro-optic medium in the first electrode segment and apply a higher electric potential to the first electrode segment associated with one of the lower or upper electrodes and a lower electric potential to the first electrode segment associated with the other of the lower or upper electrodes. The higher electric potential is greater than the lower electric potential with an average electric potential equally between the higher electric potential and the lower electric potential. The electro-optic medium between the first electrode segments being in the low transmissive state or one of the intermediate transmissive states. A high intermediate electric potential is applied to the second electrode segment associated with one of the lower or upper electrodes and a low intermediate electric potential is applied to the second electrode segment associated with the other of the lower or upper electrodes. An average electric potential between the low and high intermediate electric potentials is substantially equal to the average electric potential between the higher electric potential and the lower electric potential. The electro-optic medium between the second electrode segments is in one of the high transmissive state or a different one of the intermediate transmissive states.

According to another aspect of the present disclosure, an electro-optic device includes a first substrate having a first surface and a second surface and a second substrate having a third surface and a fourth surface. The second substrate is disposed in a substantially spaced apart relationship relative to the first substrate such that the second and third surfaces face one another to define a gap. A lower electrode is associated with the second surface and is segmented such that it defines a plurality of electrode segments including a first electrode segment and a second electrode segment adjacent to the first electrode segment. An upper electrode is associated with the third surface and is segmented substantially according to the plurality of electrode segments established by the lower electrode. An electro-optic medium is disposed in the gap between the lower and upper electrodes and configured to switch between one of a high transmissive state, an intermediate transmissive state, and a low transmission state. A control system is configured to receive an instruction to switch the state of the electro-optic medium in the first electrode segment and apply, in a first duty cycle, a higher electric potential and a lower electric potential to the first electrode segments, respectively. The higher electric potential is greater than the lower electric potential with an average electric potential equally between the higher electric potential and the lower electric potential. The electro-optic medium between the first electrode segments being in the low transmissive state or one of the intermediate transmissive states. The control system further applies, in a second duty cycle that is less than the first duty cycle, a high intermediate electric potential and a low intermediate electric potential to the second electrode segments, respectively. The electro-optic medium between the second electrode segments is in one of a high transmissive state or a different one of the intermediate transmissive states.

According to still another aspect of the present disclosure, an electro-optic device includes a first individually addressable zone and a second individually addressable zone adjacent to the first zone. A lower electrode includes a first lower electrode segment in alignment with the first zone and a second lower electrode segment in alignment with the second zone. An upper electrode includes a first upper electrode segment in alignment with the first zone and a second upper electrode segment in alignment with the second zone. An electro-optic medium is located between the lower and upper electrode segments and configured to switch between one of a high transmissive state, an intermediate transmissive state, and a low transmissive state. A control system configured to receive an instruction to switch the state of the electro-optic medium in the first zone to one of the intermediate and low transmissive states. A higher electric potential is applied to one of the first upper and lower electrode segments and a lower electric potential is applied to the other one of the first upper and lower electrode segments. The higher electric potential being greater than the lower electric potential with an average electric potential equally between the higher electric potential and the lower electric potential. A high intermediate electric potential is applied to one of the second upper and lower electrode segments and a low intermediate electric potential is applied to the other of the second upper and lower electrode segments, wherein an average intermediate electric potential between the low and high intermediate electric potentials is substantially equal to the average electric potential and the electro-optic medium in the second zone is in a more transmissive state than the first zone.

According to another aspect, the high intermediate electric potential has a first proportional relationship to the higher electric potential from the average electric potential and the low intermediate electric potential has a second proportional relationship to the lower electric potential from the average electric potential.

According to yet another aspect, a first proportional relationship and a second proportional relationship are equal.

According to still yet another aspect, a low intermediate electric potential and a high intermediate electric potential are not, individually, equal to the average electric potential between the higher electric potential and the lower electric potential.

According to yet another aspect, a low intermediate electric potential is applied to a different one of a lower or upper electrode than a lower electric potential is applied and a high intermediate electric potential is applied to a different one of the lower or upper electrode than a higher electric potential is applied.

According to another aspect, intermediate electric potentials are both substantially equal to the average electric potential.

According to yet another aspect, an electro-optic device includes at least one anodic species and at least one cathodic species.

According to still yet another aspect, a control system is configured to monitor open circuit electric potential differences, and, if the open circuit electric potential differences are not maintained within a threshold, apply corrective intermediate electric potentials.

According to still yet another aspect of the present disclosure, an electro-optic device includes a first individually addressable zone and a second individually addressable zone adjacent to the first zone. A lower electrode includes a first lower electrode segment in alignment with the first zone and a second lower electrode segment in alignment with the second zone. An upper electrode includes a first upper electrode segment in alignment with the first zone and a second upper electrode segment in alignment with the second zone. An electro-optic medium is located between the lower and upper electrode segments and configured to switch between one of a high transmissive state, an intermediate transmissive state, and a low transmissive state. A control system configured to receive an instruction to switch the state of the electro-optic medium in the first zone to one of the intermediate and low transmissive states. A higher electric potential is applied to one of the first upper and lower electrode segments and a lower electric potential is applied to the other one of the first upper and lower electrode segments. The higher electric potential being greater than the lower electric potential with an average electric potential equally between the higher electric potential and the lower electric potential. A high intermediate electric potential is associated with a voltage that is less than a voltage associated the higher electric potential is applied to one of the second upper and lower electrode segments and a low intermediate electric potential is associated with a voltage that is greater than a voltage associated with the lower electric potential is applied to the other of the second upper and lower electrode segments. An average intermediate electric potential between the low and high intermediate electric potentials is substantially equal to the average electric potential and the electro-optic medium in the second zone is in a more transmissive state than the first zone.

According to another aspect, the voltage associated with the high intermediate electric potential is less than the voltage associated with the higher electric potential by a first quantity and the voltage associated with the low intermediate electric potential is lower than the voltage associated with the lower electric potential by a second quantity that is equal to the first quantity.

According to yet another aspect, an electro-optic device includes an anodic film coupled to one of a lower and upper electrode and a cathodic film coupled to a different one of the lower and upper electrodes.

According to still yet another aspect, an electro-optic device includes at least one of an anodic buffer and a cathodic buffer.

According to still another aspect, a voltage differential between the high intermediate electric potential and the low intermediate electric potential is about half of a voltage differential between the higher electric potential and the lower electric potential.

According to another aspect, an electro-optic medium in a first zone is in a less transmissive state than the electro-optic medium in a second zone.

According to yet another aspect, the electro-optic medium in the second zone is in the intermediate transmissive state.

According to still yet another aspect, a voltage differential between the high intermediate electric potential and the low intermediate electric potential is about zero and the electro-optic medium is in the high transmissive state.

According to still another aspect of the present disclosure, an electro-optic device includes a plurality of individually addressable zones, each addressable zone including a lower electrode segment and an upper electrode segment. An electro-optic medium is located between the lower and upper electrode segments and configured to switch between one of a high transmissive state, an intermediate transmissive state, and a low transmissive state. A control system is configured to receive an instruction to switch the state of the electro-optic medium within the first zone of the plurality of zones to one of the intermediate and low transmissive states and apply a high electric potential difference to the first zone. A first intermediate electric potential difference that is less than the high electric potential difference is applied to a second zone of the plurality of zones adjacent to the first zone. A second intermediate electric potential difference that is less than the first intermediate electric potential difference is applied to a third zone of the plurality of zones adjacent to the second zone, wherein the second zone spaces the first zone from the third zone.

According to another aspect, a difference between a high electric potential and a first intermediate electric potential difference is proportional to a difference between a first intermediate electric potential difference and a second intermediate electric potential difference.

According to yet another aspect, a high electric potential difference is defined by a higher electric potential and a lower electric potential with an average electric potential equally between the higher electric potential and the lower electric potential.

According to still another aspect, a first intermediate electric potential difference is defined by a first high intermediate electric potential and a first low intermediate electric potential with an average first intermediate electric potential equally between the higher electric potential and the lower electric potential, the average first intermediate electric potential being substantially equal to the average electric potential.

According to still yet another aspect, a second intermediate electric potential difference is defined by a second high intermediate electric potential and a second low intermediate electric potential with an average second intermediate electric potential equally between the higher electric potential and the lower electric potential, the average second intermediate electric potential being substantially equal to the average electric potential.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

1. An electro-optic device, comprising:
a first individually addressable zone and a second individually addressable zone adjacent to the first zone;
a lower electrode including a first lower electrode segment in alignment with the first zone and a second lower electrode segment in alignment with the second zone;
an upper electrode including a first upper electrode segment in alignment with the first zone and a second upper electrode segment in alignment with the second zone;
an electro-optic medium located between the lower and upper electrode segments and configured to switch between one of a high transmissive state, an intermediate transmissive state, and a low transmissive state; and
a control system configured to:
receive an instruction to switch the state of the electro-optic medium in the first zone to one of the intermediate and low transmissive states;
apply a higher electric potential to one of the first upper and lower electrode segments and a lower electric potential to the other one of the first upper and lower electrode segments, the higher electric potential being greater than the lower electric potential with an average electric potential equally between the higher electric potential and the lower electric potential; and
apply a high intermediate electric potential to one of the second upper and lower electrode segments and a low intermediate electric potential to the other of the second upper and lower electrode segments, wherein an average intermediate electric potential between the low and high intermediate electric potentials is substantially equal to the average electric potential and the electro-optic medium in the second zone is in a more transmissive state than the first zone.

2. The electro-optic device of claim 1, wherein the high intermediate electric potential has a first proportional relationship to the higher electric potential from the average electric potential and the low intermediate electric potential has a second proportional relationship to the lower electric potential from the average electric potential.

3. The electro-optic device of claim 2, wherein the first proportional relationship and the second proportional relationship are substantially equal.

4. The electro-optic device of claim 3, wherein the low intermediate electric potential and the high intermediate electric potential are not, individually, equal to the average electric potential.

5. The electro-optic device of claim 1, wherein the low intermediate electric potential is applied to a different one of the lower or upper electrodes than the lower electric potential is applied, and the high intermediate electric potential is applied to a different one of the lower or upper electrodes than the higher electric potential is applied.

6. The electro-optic device of claim 1, wherein the intermediate electric potentials are both substantially equal to the average electric potential.

7. The electro-optic device of claim 1, further including at least one anodic species and at least one cathodic species.

8. The electro-optic device of claim 1, wherein the control system is further configured to:
stop applying the intermediate electric potentials in the second zone;
monitor open circuit potential differences in the second zone; and
in response to the open circuit electric potential differences not being maintained within a threshold, apply corrective intermediate electric potentials.

9. An electro-optic device, comprising:
a first individually addressable zone and a second individually addressable zone adjacent to the first zone;
a lower electrode including a first lower electrode segment in alignment with the first zone and a second lower electrode segment in alignment with the second zone;
an upper electrode including a first upper electrode segment in alignment with the first zone and a second upper electrode segment in alignment with the second zone;
an electro-optic medium located between the lower and upper electrode segments and configured to switch between one of a high transmissive state, an intermediate transmissive state, and a low transmissive state; and
a control system configured to:
receive an instruction to switch the state of the electro-optic medium in the first zone to one of the intermediate and low transmissive states;
apply a higher electric potential to one of the first upper and lower electrode segments and a lower electric potential to the other one of the first upper and lower electrode segments, the higher electric potential being greater than the lower electric potential with an average electric potential equally between the higher electric potential and the lower electric potential; and
apply a high intermediate electric potential being associated with a voltage that is less than a voltage associated the higher electric potential to one of the second upper and lower electrode segments and a low intermediate electric potential being associated with a voltage greater than a voltage associated with the lower electric potential to the other of the second upper and lower electrode segments, wherein an average intermediate electric potential between the low and high intermediate electric potentials is substantially equal to the average electric potential and the electro-optic medium in the second zone is in a more transmissive state than the first zone.

10. The electro-optic device of claim 9, wherein the voltage associated with the high intermediate electric potential is less than the voltage associated with the higher electric potential by a first quantity and the voltage associated with the low intermediate electric potential is lower than the voltage associated with the lower electric potential by a second quantity that is equal to the first quantity.

11. The electro-optic device of claim 9, further including an anodic film coupled to one of the lower and upper electrodes and a cathodic film coupled to a different one of the lower and upper electrodes.

12. The electro-optic device of claim 11, further including at least one of an anodic buffer and a cathodic buffer.

13. The electro-optic device of claim 11, wherein a voltage differential between the high intermediate electric potential and the low intermediate electric potential is about half of a voltage differential between the higher electric potential and the lower electric potential.

14. The electro-optic device of claim 13, wherein the electro-optic medium in the first zone is in a less transmissive state than the electro-optic medium in the second zone.

15. The electro-optic device of claim 14, wherein the electro-optic medium in the second zone is in the intermediate transmissive state.

16. An electro-optic device, comprising:
a plurality of individually addressable zones, each addressable zone including a lower electrode segment and an upper electrode segment;
an electro-optic medium located between the lower and upper electrode segments and configured to switch between one of a high transmissive state, an intermediate transmissive state, and a low transmissive state; and
a control system configured to:
receive an instruction to switch the state of the electro-optic medium within the first zone of the plurality of zones to one of the intermediate and low transmissive states;
apply a high electric potential difference to the first zone;
apply a first intermediate electric potential difference that is less than the high electric potential difference to a second zone of the plurality of zones adjacent to the first zone; and
apply a second intermediate electric potential difference that is less than the first intermediate electric potential difference to a third zone of the plurality of zones adjacent to the second zone, wherein the second zone spaces the first zone from the third zone.

17. The electro-optic device of claim 16, wherein a difference between the high electric potential difference and the first intermediate electric potential difference is proportional to a difference between the first intermediate electric potential difference and the second intermediate electric potential difference.

18. The electro-optic device of claim 16, wherein the high electric potential difference is defined by a higher electric potential and a lower electric potential with an average electric potential equally between the higher electric potential and the lower electric potential.

19. The electro-optic device of claim 18, wherein the first intermediate electric potential difference is defined by a first high intermediate electric potential and a first low intermediate electric potential with an average first intermediate electric potential equally between the higher electric potential and the lower electric potential, the average first intermediate electric potential being substantially equal to the average electric potential.

20. The electro-optic device of claim 18, wherein the second intermediate electric potential difference is defined by a second high intermediate electric potential and a second low intermediate electric potential with an average second intermediate electric potential equally between the higher electric potential and the lower electric potential, the average second intermediate electric potential being substantially equal to the average electric potential.
